(19) United States
(12) Patent Application Publication
(10) Pub. No.: US 2006/0221271 A1
(43) Pub. Date: Oct. 5, 2006

(54) Structure of LCD backlight module

(76) Inventor: Chen Chou Tsai, Taipei (TW)

Correspondence Address: Chen Chou Tsai, 9F., No. 37, Dongsing Road, Xinyi District, Taipei City, 110, TW

(21) Appl. No.: 11/097,805

(22) Filed: Apr. 4, 2005

(51) Int. Cl. G02F 1/1335

(52) U.S. Cl. 349/64

(57) ABSTRACT

An improved structure of LCD backlight module includes a diffuser, a reflective film and several light pipes, and the diffuser is attached at the back of an LCD panel; the reflective film is installed at the back of the diffuser with an appropriate distance apart; the light pipes are installed in parallel on an edge between the diffuser and the reflective film; an arc reflective layer is integrally formed in each light pipe; at least one light source is disposed on both ends of the light pipe, such that the light produced by the light source is guided by the reflective layer and evenly projected between the diffuser and the reflective film from the periphery, and some light pass through the diffuser directly and some light is reflected onto the diffuser by the reflective film, and the diffuser evenly spreads the light to produce a backlight for the LCD panel.

### FIELD OF THE INVENTION

The present invention relates to an improved structure of liquid crystal display (LCD) backlight module, and more particularly to a backlight module structure that produce light with even and sufficient brightness.

### BACKGROUND OF THE INVENTION

As a liquid crystal display (LCD) device mainly uses a brightness difference between a liquid crystal display panel and its backlight to produce textual and graphic displays, the quality (including brightness and evenness) of the backlight directly affects an overall display quality of the liquid crystal display. A traditional LCD backlight module structure adopts a plurality of light sources (such as a light emitting diode, LED) evenly distributed at the periphery of the backside of an LCD panel, and uses the light of a dot light source to produce a backlight at the rear side of the LCD panel. Some backlight module structures use a cold cathode fluorescent lamp as a light source, and install the cold cathode fluorescent lamp at the edge of the backside of an LCD panel to produce a backlight by a linear light source.

However, as the LCD is getting larger, the foregoing traditional backlight module structure has the following shortcomings in its applications:

1. Since the cold cathode fluorescent lamp and the dot light source (white LED) come with a limited brightness, and both are installed around the periphery of an LCD panel, therefore, there is insufficient brightness (luminance) at the center of the LCD panel, particularly when such light source is applied in a large LCD panel.

2. Cold cathode fluorescent lamps have short life and must be replaced from time to time, which is not cost-effective.

In view of the foregoing shortcomings of the prior art LCD backlight module structure, the inventor of the present invention made improvement to overcome these shortcomings, and finally invented the present invention.

### SUMMARY OF THE INVENTION

Therefore, it is a primary objective of the present invention to provide an improved structure of liquid crystal display backlight module that can produce evener and better brightness to effectively improve product competitiveness.

To achieve the foregoing objective, the present invention comprises a diffuser, a laminator, and a plurality of light pipes; wherein the diffuser is attached onto the backside of an LCD panel; a reflective film is installed at a backside of the foregoing diffusers with an appropriate distance apart; and the plurality of light pipes are installed in parallel with each other between the foregoing diffuser and the reflective film. Both ends of the light pipe comprise at least one light source and a reflective layer integrally formed and distributed in an arc shape and disposed in the light pipe, such that the light produced by the light source is refracted by a reflective layer in the light pipe and guided to be projected evenly between the diffuser and the reflective film from the periphery. With the reflective film, light can be reflected onto the diffuser, and the diffuser evenly spreads the passing light, so that the light can pass through the diffuser directly or by be reflected from the laminator to produce a backlight of the LCD panel.

The above and other objects, features and advantages of the present invention will become apparent from the following detailed description taken with the accompanying drawing.

### BRIEF DESCRIPTION OF THE DRAWINGS

FIG. 1 is an exploded view of a first preferred embodiment of the invention;

FIG. 2 is a perspective view of a first preferred embodiment of the invention;

FIG. 3 is a lateral cross-sectional view of a first preferred embodiment of the invention;

FIG. 4 is a top cross-sectional view of a first preferred embodiment of the invention;

FIG. 5 is a top cross-sectional view of a second preferred embodiment of the invention;

FIG. 6 is a top cross-sectional view of a third preferred embodiment of the invention;

FIG. 7 is an exploded view of a fourth preferred embodiment of the invention;

FIG. 8 is a perspective view of a fourth preferred embodiment of the invention;

FIG. 9 is an exploded view of a fifth preferred embodiment of the invention; and

FIG. 10 is a perspective view of a fifth preferred embodiment of the invention.

### DETAILED DESCRIPTION OF THE PREFERRED EMBODIMENTS

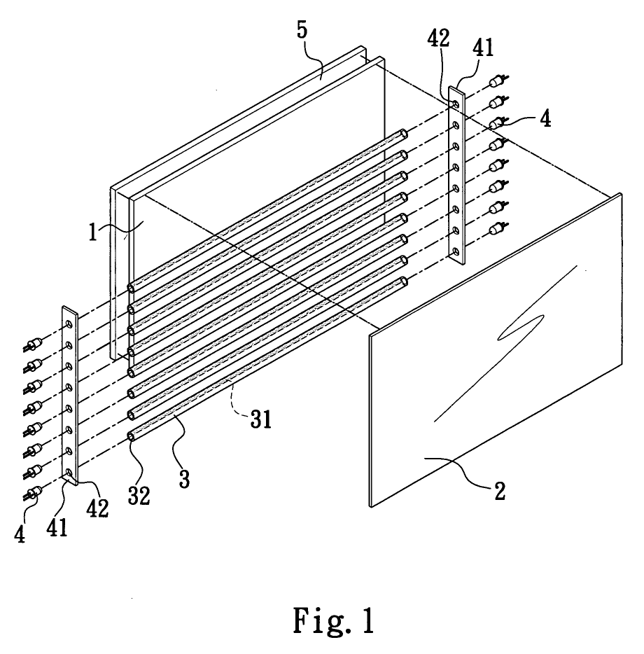

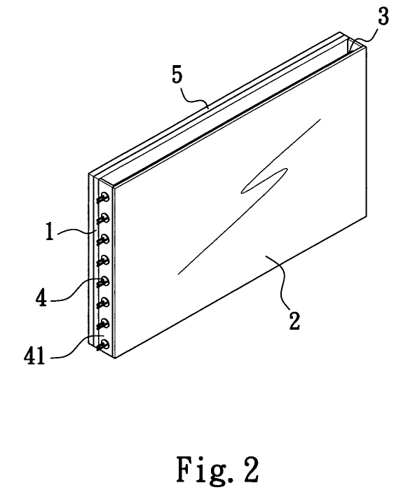

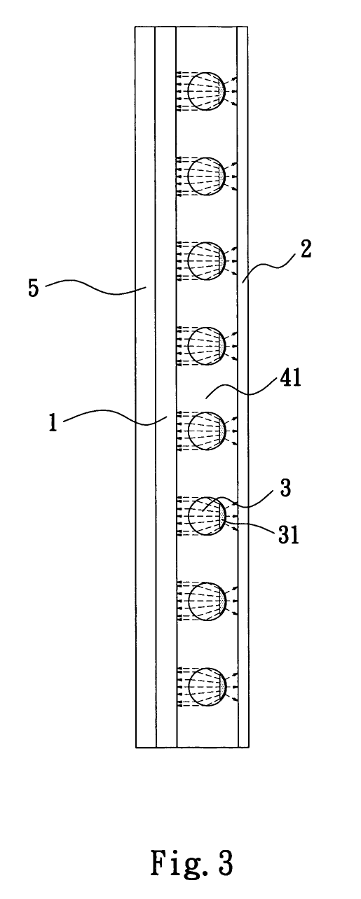

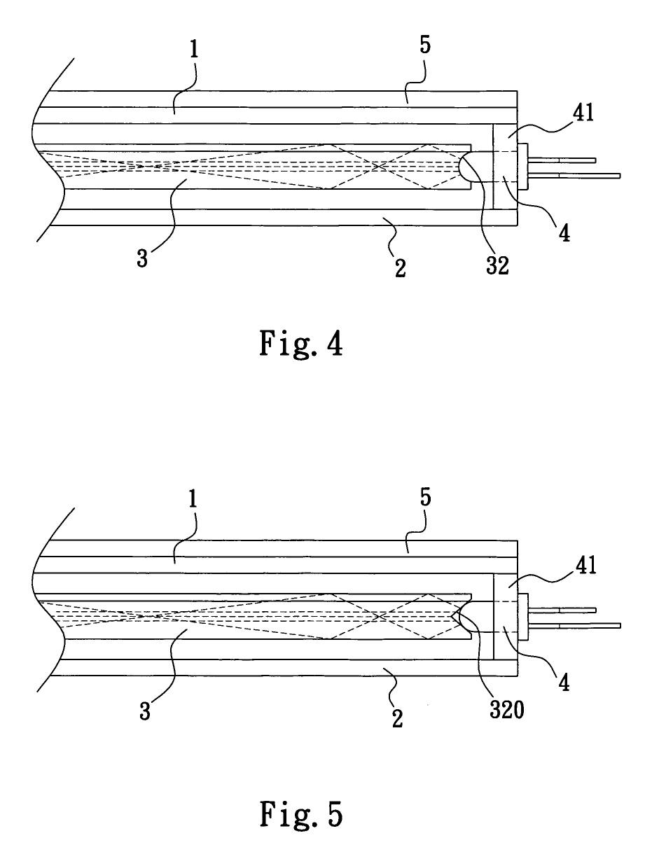

Referring to FIGS. 1 to 4 for an exploded view, a perspective view, a side view, and a top cross-sectional view of a first preferred embodiment of the present invention respectively, it is obvious that the present invention comprises a diffuser 1, a reflective film 2, a light pipe 3 and a light source 4; wherein the diffuser 1 is attached at the backside of a liquid crystal display (LCD) panel 5 for effectively and evenly passing a light; the reflective film 2 is installed at the backside of the foregoing diffuser 1 with an appropriate distance apart, and the reflective film 2 is a component made of a material generally known as SOFT and has a surface with an excellent light reflecting effect; the light pipe 3 is installed separately on two opposite sides between the foregoing diffuser 1 and reflective film 2 and is a cylindrical member made of an optical fiber material having an excellent light guiding efficiency. A reflective layer 31 (which is preferably distributed within a range of 40 degrees) is integrally formed at a side of the periphery of the light pipe 3, and a concave arc hole 32 is disposed separately on both ends of the light pipe 3. The light source 4 is a white light emitting diode (LED) separately fixed on a plurality of predetermined equidistant through holes 42 on a substrate, such that each light source 4 is embedded into the concave arc hole 32 on both ends of the light pipe 3. The light pipes 3 are installed in parallel with each other between the diffuser 1 and the reflective film 2 to constitute a secure connection.

In this embodiment, the reflective layer 31 is installed in a direction facing the reflective film 2, and thus when the light produced by the light source 4 is guided by the high-efficient light pipe 3 and randomly reflected by the reflective layer 31 and projected at a direction of a refraction of 90 degrees between the diffuser 1 and the reflective film 2. A vast majority of the light passes through the diffuser 1 directly, and a small portion of the light is reflected by the reflective film 2 and passes through the diffuser, so that the passing light are spread evenly by the diffuser 1 to produce a backlight of the LCD panel 5.

Referring to FIG. 5, a top cross-sectional view of a second preferred embodiment of the present invention is illustrated. In FIG. 5, a conical concave hole 320 is disposed separately on both ends of the light pipe 3 for accommodating each light source 4, and the structure of each component has the same characteristics of the foregoing first preferred embodiment and thus will not be described here.

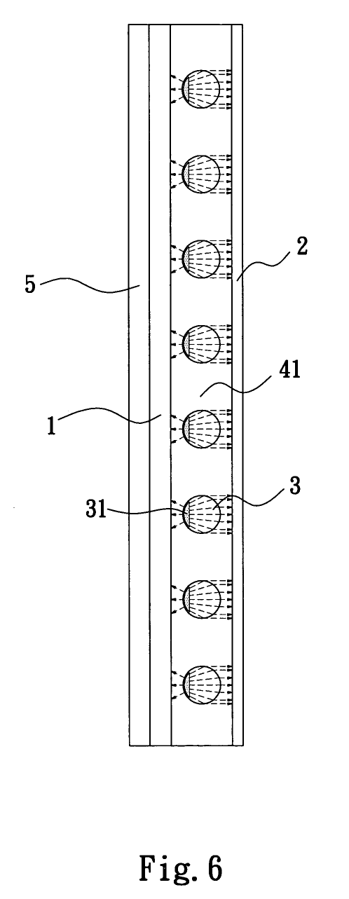

Referring to FIG. 6, a lateral cross-sectional view of a third preferred embodiment of the present invention is illustrated. In FIG. 6, the reflective layer 31 is installed in a direction facing the diffuser 1, so that when the light pipe 3 refracts the light at 90 degrees, a small portion of the light can pass through the diffuser 1 directly, and a vast majority of the light is reflected by the reflective film 2 and passes through the diffuser 1. The diffuser 1 evenly spreads the passing light to produce another form of backlight of the LCD panel 5.

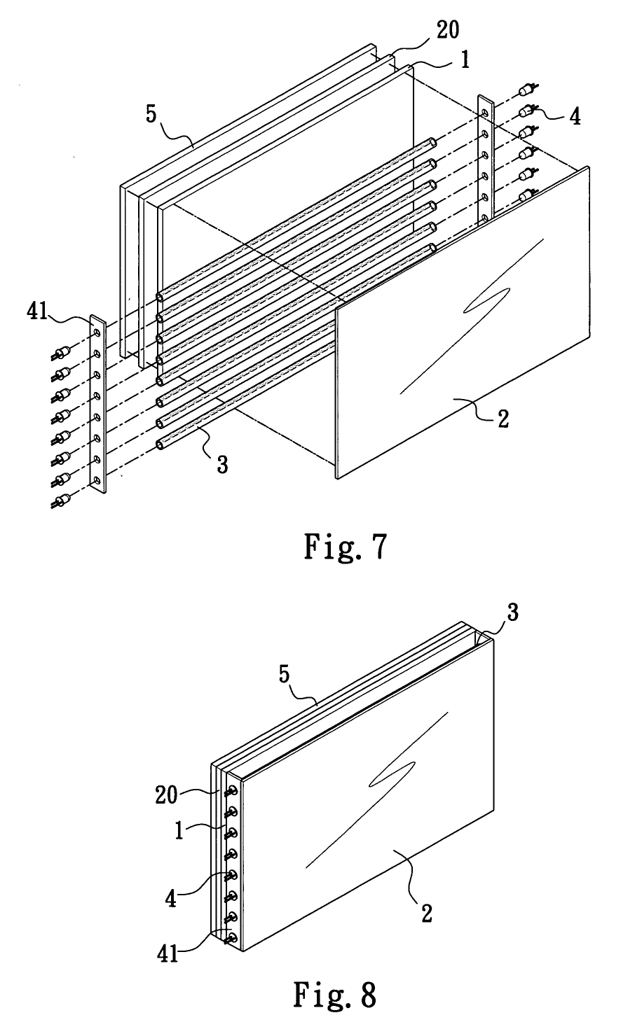

Referring to FIGS. 7 and 8, an exploded view and a perspective view of a fourth preferred embodiment of the present invention are illustrated respectively. In FIGS. 7 and 8, a reflective film 20 is installed between the LCD panel 5 and the diffuser 1 of the foregoing first preferred embodiment, such that the light goes through a multiple times of reflections, and thus achieving an evener effect.

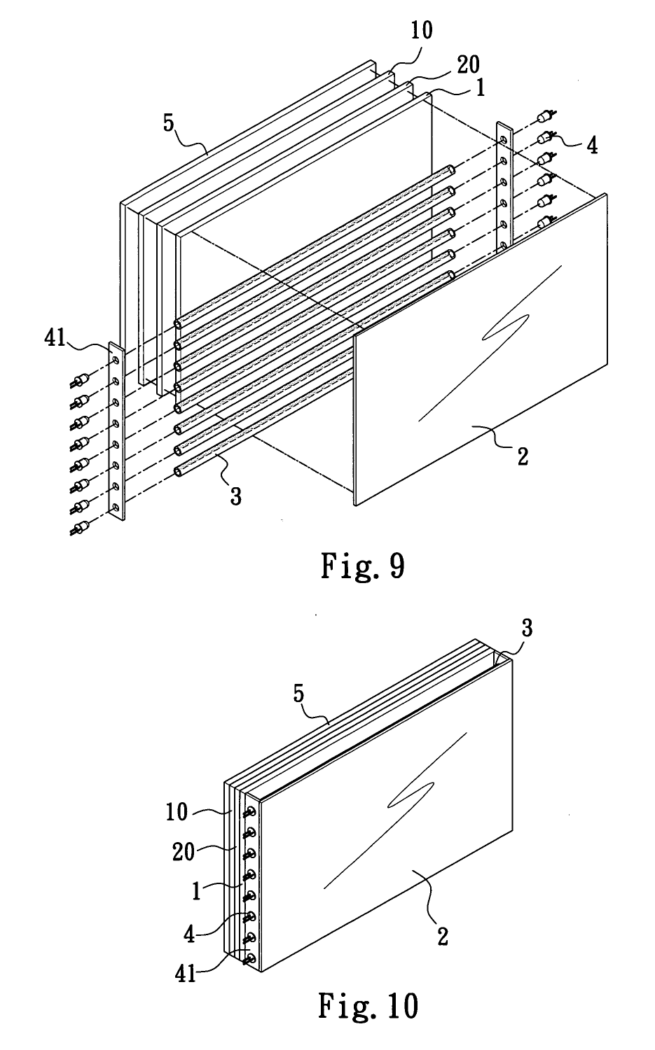

Referring to FIGS. 9 and 10, an exploded view and a perspective view of a fifth preferred embodiment of the present invention are illustrated respectively. In FIGS. 9 and 10, the fifth preferred embodiment adopts the basic structure of the foregoing fourth preferred embodiment, and another diffuser 10 is installed between the LCD panel 5 and the reflective film 20, so that before the light is projected onto the LCD panel 5, the light passes through the diffuser for an even diffusion and gives an evener effect.

In view of the description above, the improved structure of LCD backlight module in accordance with the present invention has better brightness, evener luminance, and thus the invention is useful and novel in the industry, and has improvements over the prior arts.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved structure of LCD backlight module, comprising:
at least one diffuser, attached onto a backside of an LCD panel for effectively and evenly passing a light;
at least one reflective film, disposed at a backside of said diffuser with an appropriate distance apart;
a plurality of light pipes, installed in parallel between said diffuser and said reflective film, and said each light pipe having a reflective layer extended in an arc shape in said light pipe;
a plurality of light sources, disposed at both ends of said light pipe, such that the light produced said light source is passed into said light pipe and guided between said diffuser and said reflective film by said reflective layer, and said light passes through or reflected by said reflective film into said diffuser and is evenly diffused to produce a backlight of said LCD panel.

2. The improved structure of LCD backlight module of claim 1, wherein said light pipe has a concave hole at both ends.

3. The improved structure of LCD backlight module of claim 1 or claim 2, wherein said reflective layer is integrally formed in said light pipe and is preferable disposed within a range of 40 degrees.

4. The improved structure of LCD backlight module of claim 1 or claim 2, wherein said light source is a white light emitting diode separately installed into a predetermined equidistant through holes on a substrate.

5. The improved structure of LCD backlight module of claim 1 or claim 2, wherein said reflective layer is installed in a direction facing said diffuser.

6. The improved structure of LCD backlight module of claim 1 or claim 2, wherein said reflective layer is installed in a direction facing said reflective film.

7. The improved structure of LCD backlight module of claim 1 or claim 2, further comprising another reflective film disposed between said LCD panel and said diffuser.

8. The improved structure of LCD backlight module of claim 7, further comprising another diffuser disposed between said LCD panel and said diffuser.
